(19) United States
(12) Patent Application Publication
(10) Pub. No.: US 2017/0282792 A1
(43) Pub. Date: Oct. 5, 2017

(54) DETECTION SYSTEM FOR A MOTOR VEHICLE, FOR INDICATING WITH THE AID OF A SOUND STAGE A LACK OF VIGILANCE ON THE PART OF THE DRIVER

(71) Applicant: RENAULT s.a.s., Boulogne-Billancourt (FR)

(72) Inventor: Herve ILLY, Meudon (FR)

(73) Assignee: RENAULT s.a.s., Boulogne-Billancourt (FR)

(21) Appl. No.: 15/317,429

(22) PCT Filed: Jun. 8, 2015
(86) PCT No.: PCT/FR2015/051513

§ 371 Date: Jan. 27, 2017

(30) Foreign Application Priority Data
Jun. 10, 2014 (FR) 1455237

(51) Int. Cl. B60Q 9/00; G06K 9/00; H04S 5/00

(52) U.S. Cl. CPC B60Q 9/00; H04S 5/00; G06K 9/00845

(57) ABSTRACT

A system detects a lack of vigilance by a driver of a motor vehicle. The system includes a first monitoring unit to assess whether the vigilance of the driver is or is not above a vigilance threshold, at least two distinct loudspeakers, and a sound stage generator to control the at least two loudspeakers so as to simulate a stereophonic sound originating from a virtual sound source that is mobile relative to a seat of the driver when the vigilance of the driver becomes less than the vigilance threshold.

The subject of the invention is the safety systems for motor vehicles and more particularly the systems intended to limit the risks associated with driving in a state of diminished vigilance of the driver of the vehicle.

Systems for detecting a lowering of vigilance of the driver do exist. These systems can for example be linked to a monitoring of micro-movements of the driver on the steering wheel to an analysis of images of the visual expressions of the face of the driver, to sensors in the seat monitoring the bearing points of the body and more particularly the head of the driver.

When a lowering of vigilance is detected, alerts are provided for the attention of the driver such as, for example, a visual display on the dashboard, a tactile alert in the form of a vibration in the steering wheel or the seat, or an acoustic signal such as, for example, a ringer. Thus, for example, in the patent application EP 131 2499 when a detection system detects that the vehicle is in the process of leaving its lane, the system emits three alert levels, an optical alert level, an acoustic alert level and a vibratory alert level in the seat or the steering wheel.

Other alert systems that already exist warn, for example, that the driver is in a distracted state by a sound signal accompanied by a display of a message of “break advised” type, for example by displaying a small coffee cup. The patent application EP 20 42 398 proposes emitting a sound signal or a light signal at the moment when a monitoring system detects that the vehicle leaves its lane or detects that the driver performs an inappropriate action in a lane changing context.

Alert modalities proposed in these embodiments risk either being unseen by the driver if the latter in a state of diminished awareness is already not watching his or her dashboard, or risk increasing the confusion of the driver if the latter can no longer remember with which type of alarm the ringer that he or she is hearing is linked. The alert can provoke abrupt gestures also risking affecting the trajectory, for example in the case of vibration reawaking the driver with a jump from his or her micro-sleep.

The aim of the invention is to propose a detection system which interacts with the driver in such a way as to make the driver aware, effectively, of his or her lack of vigilance.

To this end, the invention proposes a system for detecting a lack of vigilance on the part of a driver of a motor vehicle, comprising a first monitoring unit capable of assessing whether the vigilance of the driver is or is not above a vigilance threshold. The detection system comprises at least two distinct loudspeakers, and further comprises a sound stage generator configured to control the at least two loudspeakers so as to simulate a stereophonic sound originating from a virtual sound source that is mobile relative to the seat of the driver when the vigilance of the driver becomes less than the vigilance threshold.

The sound stage generator can be configured to simulate a mobile virtual sound source each time the vigilance level of the driver becomes less than the vigilance threshold.

The detection system can comprise at least one second monitoring unit configured to identify at least one type of danger linked to the trajectory and/or to the environment of the vehicle. The sound stage generator may be configured to simulate a mobile virtual sound source only when the monitoring unit detects a danger associated with the trajectory conjointly with the lack of vigilance. The first and the second monitoring unit may be distinct within one and the same control unit, or may be combined. The second monitoring unit may be configured to identify at least one predefined type of danger linked to the trajectory and/or to the environment of the vehicle, and the sound stage generator may be configured to simulate a mobile virtual sound source, the movement or sound of which is different depending on whether the vigilance level is detected alone or is detected conjointly with the predefined type of danger.

According to one embodiment, the sound stage generator is configured to associate at least two different sound stages with two different types of dangers.

According to one embodiment, the sound stage generator can be configured to select the same pattern of stereophonic sound whatever the danger detected at the moment at which the vigilance is below the threshold. According to yet another embodiment, the sound stage generator may emit a first type of sound stage as soon as the vigilance threshold is crossed, and then modify the type of sound stage if a danger is identified thereafter before the driver has snapped out of his or her state of hypovigilance.

Preferably, the sound stage generator is connected to at least three distinct loudspeakers, including at least one loudspeaker on the right and one loudspeaker on the left of the driver's seat, at least two of the at least three loudspeakers being further spaced apart in the direction of advance of the vehicle.

The detection system according to the invention may comprise sensors of the posture or attitude of the driver, which are connected to the first monitoring unit.

The detection system according to the invention may comprise sensors able to quantify the driving actions of the driver, which are connected to the first monitoring unit.

The detection system according to the invention may comprise sensors able to quantify a conformity of the trajectory of the vehicle with respect to an array of desirable trajectories, which are connected to the first monitoring unit.

The sensors able to quantify a conformity of the trajectory of the vehicle with respect to an array of desirable trajectories, may advantageously also be connected to a second monitoring unit configured to identify at least one type of danger associated with the trajectory and/or with the environment of the vehicle, according to criteria distinct from those applied by the first monitoring unit. These sensors may thus be used both for detecting a state of hypovigilance of the driver and for detecting a danger posing a concrete threat to the vehicle if the trajectory of the vehicle is not modified in the short term.

According to one advantageous embodiment, the sound stage generator is configured, when the vigilance of the driver becomes less than the vigilance threshold, to simulate a virtual sound source swirling in a horizontal plane around the driver.

The loudspeakers are preferably installed in the vehicle in such a way that at least two loudspeakers are located at a distance from one another of at least fifty centimeters, so as to be able to obtain a stereophonic effect. Preferably the system comprises at least four loudspeakers, two situated with one on the right and the other on the left relative to the driver's seat, in front of the driver's seat or level therewith, and two loudspeakers situated with one on the right and the other on the left relative to the driver's seat, and offset toward the rear of the vehicle relative to the first two loudspeakers. Preferably, the sound stage generator is configured to be connected to at least three distinct loudspeakers, at least one being a loudspeaker on the right and one a loudspeaker on the left of the driver's seat, at least two of the at least three loudspeakers also being spaced apart in the direction of advance of the vehicle. It is thus possible to simulate virtual sound sources situated to the right or to the left of the driver, to the front or to the rear relative to the driver, and to simulate a backward movement of the virtual sound source. Even if the virtual source is mobile, its movement is preferably a continuous movement or a repetition of continuous movements, so as to be able to be located intuitively by the driver and not to induce unease associated with difficulty in interpreting the sound stage.

Other aims, features and advantages of the invention will become apparent on reading the following description, given purely as a non-limiting example, and with reference to the attached figures in which:

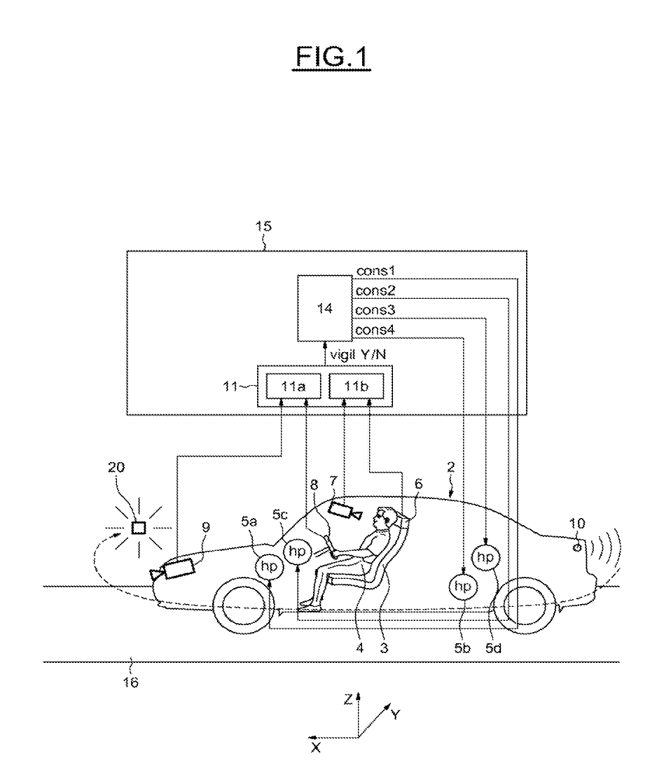

FIG. 1 illustrates a motor vehicle equipped with a detection system according to the invention,

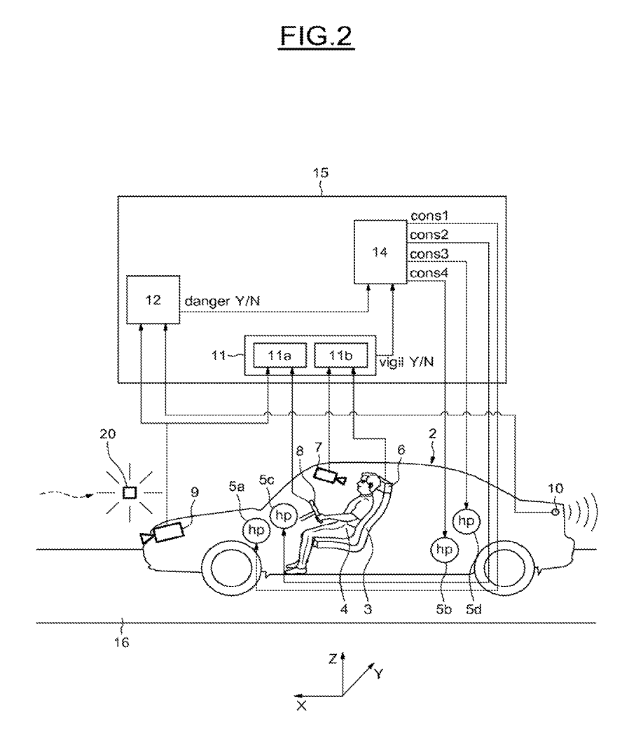

FIG. 2 illustrates another motor vehicle equipped with another detection system according to the invention.

As illustrated in FIG. 1, a detection system 1 equips a vehicle 2 comprising a seat 3 intended to receive a driver 4. In the example illustrated, when a driver 4 is sitting on the seat 3, he or she is within the field of a camera 7 for monitoring the attitude of the driver, actuates a steering wheel 8 of the vehicle, acts on motion sensors 6 located in the seat 3 of the vehicle. The sensors 6, and the camera 7, or more generally at least one sensor suitable for monitoring the posture, behavior or physiology of the driver, are linked to a module 11b monitoring the behavior of the driver, which emits a first estimation concerning the level of vigilance of the driver.

The vehicle 2 is also equipped with a camera 9 making it possible to monitor the roadway 16 on which the vehicle is running and any obstacles located at the edges of the roadway. The vehicle can also be equipped with one or more radars 10 making it possible to detect obstacles in proximity to the vehicle, for example a vehicle which is approaching too close to the rear of the equipped vehicle, or an obstacle located in front of the vehicle 2. The steering wheel 8 is, here equipped with at least one sensor making it possible to measure the steering wheel angle variations imposed by the driver. The sensor of the steering wheel 8, and the camera 9, or more generally at least one sensor monitoring at least one driving modality of the driver, are linked to a module 11a monitoring driving actions of the driver. This monitoring module 11a monitors the way in which the driver interacts with the vehicle, for example monitors the micro-movements of the steering wheel which do not affect the trajectory, and/or monitors the regularity of the trajectory and/or how well it matches the line of the road. Modalities for monitoring the physiology, and modalities for monitoring the behavior of the driver in order to assess the level of vigilance of the driver are known.

The module 11a and the module 11b form part of a first monitoring unit 11, which, based on the analyses of the modules 11a and 11b emits a “vigil” variable reflecting an estimated level of vigilance with the driver. The modules 11a and 11b can process the variables from the physiological sensors and the variables from the driving action sensors independently or can supply intermediate variables re-analyzed jointly by the monitoring unit 11. This variable crosses a threshold when the level of vigilance of the driver becomes unsatisfactory. The “vigil” variable can be boolean type, or can be a continuous variable to which can be assigned a threshold reflecting a limit level of vigilance of the driver.

The first monitoring unit 11 forms part of an electronic control unit 15 further comprising a sound stage generator 14.

The sound stage generator 14 receives the “vigil” variable which translates the state of vigilance of the driver 4.

The vehicle comprises a plurality of loudspeakers 5a, 5b, 5c and 5d, four in this instance, which are preferably distributed in such a way that at least three loudspeakers are spaced apart in pairs in a horizontal plane XY, so as to be able to simulate the virtual sources moving around in various directions in this plane XY relative to the vehicle. These loudspeakers can have multiple functions, for example can have a standard function of broadcasting an ambient sound installation of the vehicle, by being linked to a radio, to an audio storage drive, and/or a hands-free device for a smartphone. If there are more than two of the loudspeakers, they can be distributed also at different heights relative to the driver and can make it possible to simulate a virtual source that is mobile also relative to a vertical axis Z.

Generally, and for the rest of the explanations, the “vigil” variable decreases when the vigilance of the driver diminishes, but equivalent embodiments are of course possible with a “vigil” variable which increases when the vigilance of the driver is degraded. The “vigil” variable can also be a boolean.

If the level of vigilance of the driver 4 therefore passes below a certain threshold, the sound stage generator 14 sends sound signal setpoints cons1, cons2, cons3, cons4, which are variable as a function of time, respectively to the four loudspeakers 5a, 5c, 5d, 5b so as to produce a sound stage pattern which the driver can easily identify with a lack of vigilance alert. The time patterns defined by the four setpoints cons1, cons2, cons3, cons4 differ by their phase and/or by their intensity so as to generate a stereophonic sound and to create the illusion for the driver of a virtual sound source which is in motion relative to the driver. In this way, the driver perceives the sound stage as a message that is clearly distinct from the background noises, clearly distinct from the other immobile spot sound messages, even distinct from background music that is stereophonic but involves no movement in the musical source or sources.

Stereophonic sound should be understood to mean a sound which, for a person situated at a given point, here for a person seated on the seat 3 of the driver, seems to originate from a virtual sound source 20 located at a point of space which does not necessarily correspond to the position of one of the loudspeakers, this sound source being able to move around in this space by virtue of the driving by the sound stage generator 14, the phase shifts between the different sound patterns and between the volumes of the different sound patterns emitted by each of the loudspeakers 5a, 5b, 5c, 5d. A sound stage should be understood here to mean an emission of stereophonic sound with a movement of the virtual sound source of the stereophonic sound. As illustrated in FIG. 1, a virtual sound source 20 can thus swirl around the driver, for example swirl in a horizontal plane XY around the driver.

Virtual sound source should be understood to mean the point of space from which the sound ought to be emitted, to be perceived equivalently by the driver if the sound were emitted by a real spot source instead of being emitted by the different loudspeakers of the vehicle.

The direction and the rate of movement of the virtual sound source 20, the amplitude or the frequency of the sound, can be modulated as a function of the level of vigilance of the driver initially detected as inadequate, and can also be modulated as a function of the detection or non-detection of a reaction on the part of the driver to the first sound message which is addressed to him or her during one and the same episode of lack of vigilance.

The sound stage generator 14 can for example be configured to use the same type of stereophonic sound as soon as the level of vigilance of the driver drops below a certain threshold. The associated sound may for example be a sound coming from a virtual sound source 20 swirling around the driver, or swirling or effecting a periodic movement in the vicinity of the driver, so that this type of alarm cannot be confused with other alarms regarding the state of operation of the vehicle.

FIG. 2 illustrates another detection system according to the invention. FIG. 2 again depicts elements that are common to FIG. 1, the same elements being denoted by the same references. The electronic control unit 15 here comprises a second monitoring unit 12 configured to identify, for example using the camera 9 or the radar 10, an immediate danger to the vehicle resulting from the trajectory and/or from the environment of the vehicle.

The second monitoring unit 12 thus emits one or more “danger” variables for the attention of the sound stage generator 14 which also receives the “'vigil” variable translating the stat of vigilance of the driver 4. The monitoring unit 12 may emit one single Boolean variable indicating the absence of danger or on the other hand indicating the presence of any danger from a list of predefined dangers. According to another alternative form of embodiment, the monitoring unit 12 may emit one Boolean variable per danger type (trajectory deviation to the left, trajectory deviation to the right, vehicle approaching from the rear, obstacle in front that the vehicle is approaching, etc.) or may, again according to another alternative form of embodiment, emit an integer variable, each value of the variable being associated with one particular type of danger. In an embodiment illustrated in FIG. 2, the sound stage generator does not trigger the generation of the stereophonic alert signal unless a danger is detected conjointly with the lack of vigilance. In another embodiment, the sound stage generator already triggers the generation of a first stereophonic alert signal with a mobile virtual source even if only hypovigilance is detected, and possibly thereafter triggers the generation of another stereophonic alert signal, for example with a different movement virtual source if hypovigilance is detected conjointly with a situation presenting danger to the vehicle. According to yet another embodiment, the sound stage generator already triggers the generation of a first stereophonic alert signal with a mobile virtual source as soon as hypovigilance is detected, and thereafter triggers the generation of another stereophonic alert signal if a danger is also detected, the nature of the other alert message being dependent on the type of danger detected. If the danger is detected before or conjointly with the lack of vigilance of the driver, the stereophonic alert signal emitted may be directly a signal associated with the presence of the danger. In the embodiment illustrated in FIG. 2 for example, since a danger approaching the vehicle from the front has been detected, the sound stage generator 14 sends setpoints cons1, cons2, cons3, cons4 to the loudspeakers so as to simulate a virtual sound source 20 also approaching the driver from the front, so as to alert the driver as to where the danger is coming from.

The camera 9 and the radar 10 can be linked to the second monitoring unit 12 so as to monitor the trajectory and the environment of the vehicle, for example so as to monitor the conformity of the trajectory relative to the line of the road. The unit can check that the trajectory of the vehicle lies within an envelope of “safe” trajectories which can be wider than the envelope of trajectories indicating the vigilance on the part of the driver. The environment analyzed by the monitoring unit 12 can comprise obstacles or vehicles detected in front of or behind the vehicle, for example detected by the camera 9 or by the radar 10.

The invention is not limited to the exemplary embodiments described and can be broken down into many variants. The monitoring units 11, 12 and the sound stage generator 14 can be independent entities or can be grouped together within one and the same electronic control unit 15. The modalities for detection of a lack of vigilance on the part of the driver can be different from those described. The modes for detecting dangers linked to the trajectory of the vehicle and to the surrounding obstacles can also vary.

The detection of the vigilance of the driver can be based solely on one or more physiological measurements, be based solely on one or more measurements of the driving mode, be based solely on the quality of the trajectory, or be realized by a hybrid mode combining two or more of these detection modalities. The methods for detecting the level of vigilance of the driver can involve fewer sensors than the sensors described, or, on the contrary, use additional sensors of a physiological state of the driver (heart rate) or additional sensors of actions of the driver (frequency and mode of intervention on the control elements of the dashboard for example).

Several levels of intensity of sound stage stereophonic messages can be provided, notably for the cases where the driver does not react in such a way as to give a perception of an upsurge of vigilance above a threshold, following the first warning stereophonic signal during a given lack-of-vigilance episode.

The detection system according to the invention makes it possible to warn the driver of a lack of vigilance by minimizing the possibilities of the driver to ignore the message, and by facilitating the perception by the driver of the message in the midst of the background noises usually encountered in the automobile context.

1-10. (canceled)

11. A system for detecting a lack of vigilance by a driver of a motor vehicle, comprising:
a first monitoring unit configured to assess whether the vigilance of the driver is or is not above a vigilance threshold;
at least two distinct loudspeakers; and
a sound stage generator configured to control the at least two loudspeakers so as to simulate a stereophonic sound originating from a virtual sound source that is mobile relative to a seat of the driver when the vigilance of the driver becomes less than the vigilance threshold.

12. The detection system as claimed in claim 11, in which the sound stage generator is configured to simulate a mobile virtual sound source each time the vigilance level of the driver becomes less than the vigilance threshold.

13. The detection system as claimed in claim 12, further comprising at least one second monitoring unit configured to identify at least one predefined type of danger linked to a trajectory and/or to an environment of the vehicle, in which the sound stage generator is configured to simulate a mobile virtual sound source, a movement or sound of which is different depending on whether the vigilance level is detected alone or is detected conjointly with the predefined type of danger.

14. The detection system as claimed in claim 13, in which the sound stage generator is configured to associate at least two different sound stages with two different types of dangers.

15. The detection system as claimed in claim 14, in which the sound stage generator is connected to at least three distinct loudspeakers, including at least one loudspeaker on a right of the seat of the driver and one loudspeaker on a left of the seat of the driver, at least two of the at least three loudspeakers being further spaced apart in a direction of advance of the vehicle.

16. The detection system as claimed in claim 11, further comprising at least one sensor of a posture or attitude of the driver, which is connected to the first monitoring unit.

17. The detection system as claimed in claim 11, further comprising at least one sensor configured to quantify driving actions of the driver, which is connected to the first monitoring unit.

18. The detection system as claimed in claim 11, further comprising at least one sensor configured to quantify a conformity of a trajectory of the vehicle with respect to an array of desirable trajectories, which is connected to the first monitoring unit.

19. The detection system as claimed in claim 18, in which the at least one sensor able to quantify a conformity of the trajectory of the vehicle with respect to an array of desirable trajectories is also connected to a second monitoring unit configured to identify at least one type of danger associated with the trajectory and/or with an environment of the vehicle, according to criteria distinct from those applied by the first monitoring unit.

20. The detection system as claimed in claim 11, in which the sound stage generator is configured, when the vigilance of the driver becomes less than the vigilance threshold, to simulate a virtual sound source swirling in a horizontal plane around the seat of the driver.
